(19) United States
(12) Patent Application Publication
(10) Pub. No.: US 2011/0006067 A1
(43) Pub. Date: Jan. 13, 2011

(54) ONE-PIECE WATER METER PIT FRAME

(76) Inventors: Nathan Manuel, Redondo Beach, CA (US); Margaret McCanless, El Segundo, CA (US)

Correspondence Address: CARLSON, GASKEY & OLDS, P.C., 400 WEST MAPLE ROAD, SUITE 350, BIRMINGHAM, MI, 48009, US

(21) Appl. No.: 12/830,593

(22) Filed: Jul. 6, 2010

Related U.S. Application Data
(60) Provisional application No. 61/224,161, filed on Jul. 9, 2009.

(51) Int. Cl. B65D 88/76; B28B 1/20; B29C 45/00; B29C 51/42

(52) U.S. Cl. 220/484; 264/311; 264/328.1; 264/319

(57) ABSTRACT

A water meter pit assembly includes a roto-molded frame to be supported by a meter pit column. The meter pit frame comprises a one-piece component having a base portion to be supported on the meter pit column and a top portion to be releasably secured to the frame so that the plastic cover can be detached when needed to provide access to water meter components that are located within the water meter pit.

### RELATED APPLICATION

This application claims priority to U.S. Provisional Application 61/224,161 filed on Jul. 9, 2009.

### TECHNICAL FIELD

The present invention relates to a water meter pit frame that is molded as a single-piece component.

### BACKGROUND OF THE INVENTION

Water meters are used to monitor the amount of water distributed to specific locations, such as municipalities, businesses, and residences for example. Typically, a water meter is placed in a pit that is dug into the ground. A water supply pipe extends across a bottom of the pit and the water meter is installed to monitor the water flow. A column extends upwardly from a bottom of the pit and supports a meter pit frame assembly. The frame assembly is typically made up of various frame portions that are attached together to form a final frame structure. A cover fits over the meter pit frame assembly to enclose the water pit. The cover is usually flush with ground level, thus the frame assembly and cover must be sufficiently strong to support significant weight loads.

### SUMMARY OF THE INVENTION

A water meter pit assembly includes a roto-molded frame to be supported by a meter pit column. The meter pit frame comprises a one-piece component having a base portion to be supported on the meter pit column and a top portion to be releasably secured to the frame.

In one example, the water meter pit assembly includes a one-piece plastic frame having an outer surface extending from the base portion to the top portion.

In one example, the frame has an inward arched frame shape.

In one example, the frame includes a plurality of ribs extending outwardly from the outer surface of the frame.

In one example, the ribs are defined by arcuate surfaces extending along their length and width.

In one example, the frame tapers in an inward direction from the base portion to the top portion.

In one example, the frame includes an outer wall structure and an inner wall structure spaced radially inward of the outer wall structure to form a pocket area. The inner wall includes an upper surface that is spaced vertically below an upper surface of the outer wall structure. The inner and outer wall structures each taper in an inward direction from a bottom end to a top end.

These and other features of the present invention can be best understood from the following specification and drawings, the following of which is a brief description.

### BRIEF DESCRIPTION OF THE DRAWINGS

FIG. 1 is a schematic representation of a water meter pit assembly supported on a column located within an opening within the ground.

FIG. 2 is a top iso view of a water meter pit frame of FIG. 1.

FIG. 3 is a top view of the water meter pit frame of FIG. 1.

FIG. 4 is a side view of the water meter pit frame of FIG. 1.

FIG. 5 is a bottom view of the water meter pit frame of FIG. 1.

FIG. 6 is bottom iso view of the water meter pit frame of FIG. 1, and which includes a frost plate.

FIG. 7 is a cross-sectional view of the water meter pit frame of FIG. 6.

FIG. 8 is a partial cross-sectional view showing an arched rib structure.

FIG. 9 is a partial side view showing an external arched rib structure in combination with an inward arched frame shape.

FIG. 10 is a top iso view of another example of a water meter pit frame.

FIG. 11 is a top view of the water meter pit frame of FIG. 10.

FIG. 12 is a side view of the water meter pit frame of FIG. 10.

FIG. 13 is a bottom view of the water meter pit frame of FIG. 10.

FIG. 14 is a top iso view of the water meter pit frame of FIG. 10, and which includes a frost plate.

FIG. 15 is a cross-sectional view of the water meter pit frame of FIG. 14.

FIG. 16 is a partial cross-sectional view showing an arched rib structure and frost plate support structure.

FIG. 17 is a partial side view showing an external arched rib structure.

FIG. 18 is a cross-sectional side view showing inner and outer wall structures of the frame of FIG. 10.

### DETAILED DESCRIPTION OF THE PREFERRED EMBODIMENT

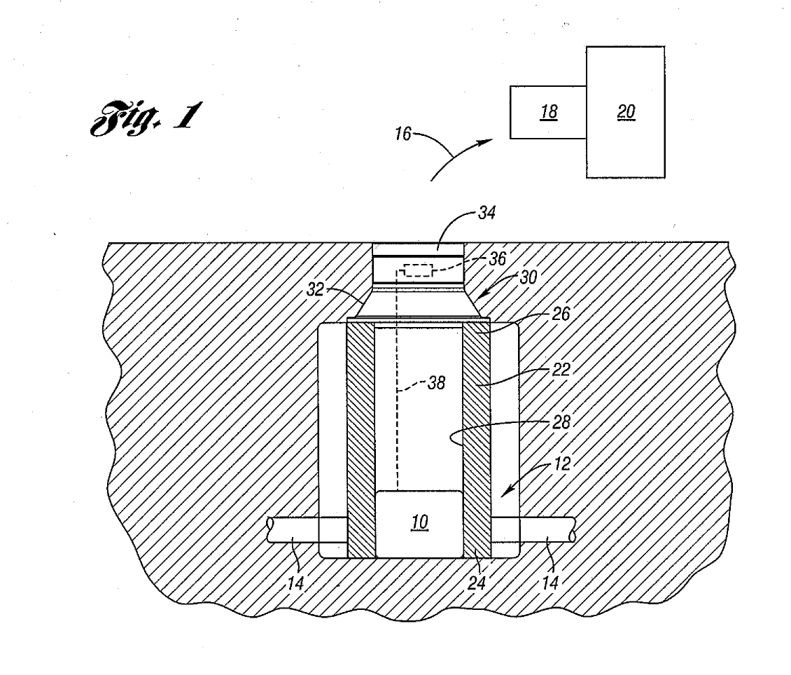

A water meter 10 is located in a pit 12 that is dug in the ground as shown in FIG. 1. A water supply pipe 14, which is buried underground and extends across a bottom of the pit 12, is used to deliver water to specific locations, such as a businesses or residences for example. The water meter 10 monitors and measures the amount of water that is used for a specific location. This water meter data is transmitted via a wireless signal 16 to a receiving device 18 associated with a data collection device 20, such as a computer or hand-held meter reader for example, which is located above ground.

A water pit column 22 includes a first end 24 that is supported on a floor of the pit 12, and which extends upwardly to a second end 26. The water pit column 22 includes a central opening 28 that extends from the first end 24 to the second end 26. The water meter 10 is at least partly received within this central opening 28.

A water meter pit assembly 30 rests on top of the second end 26 of the water pit column 22. The water meter pit assembly 30 includes a one-piece plastic frame 32 and a plastic cover 34 that is releasably secured to the plastic frame 32 such that the plastic cover 34 can be selectively attached and detached from the plastic frame 32 to provide access to components located within the pit 12. The plastic cover 34 is usually positioned to be flush with ground level but could also be slightly raised or lowered relative to ground level.

The plastic frame 32 supports a transmitting component 36, such as a signal generator for example, that is connected to the water meter 10 with at least one wire connection 38. The wire connection 38 extends downwardly from the plastic frame 32 through the central opening 28 in the water pit column 22, to a location where the wire is connected to the water meter 10. Data from the water meter 10 is then wirelessly transmitted by the transmitting component 36 to the receiving device 18. Any type of transmitting component and receiving device can be used to transmit and receive data from the water meter 10.

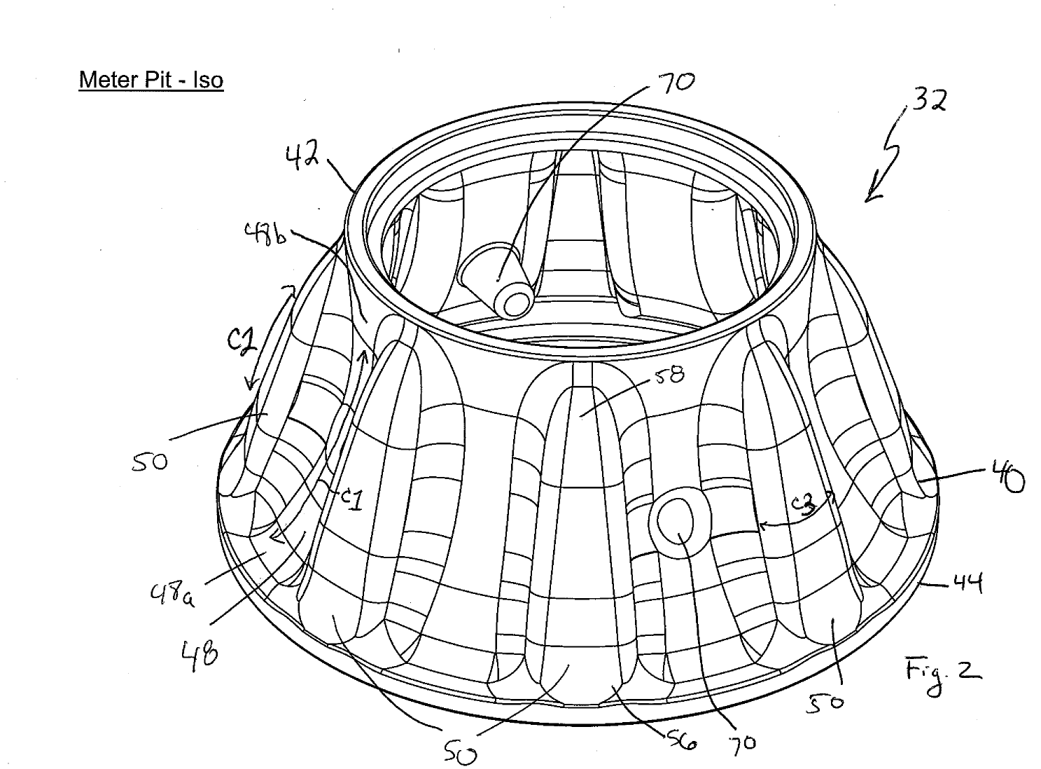

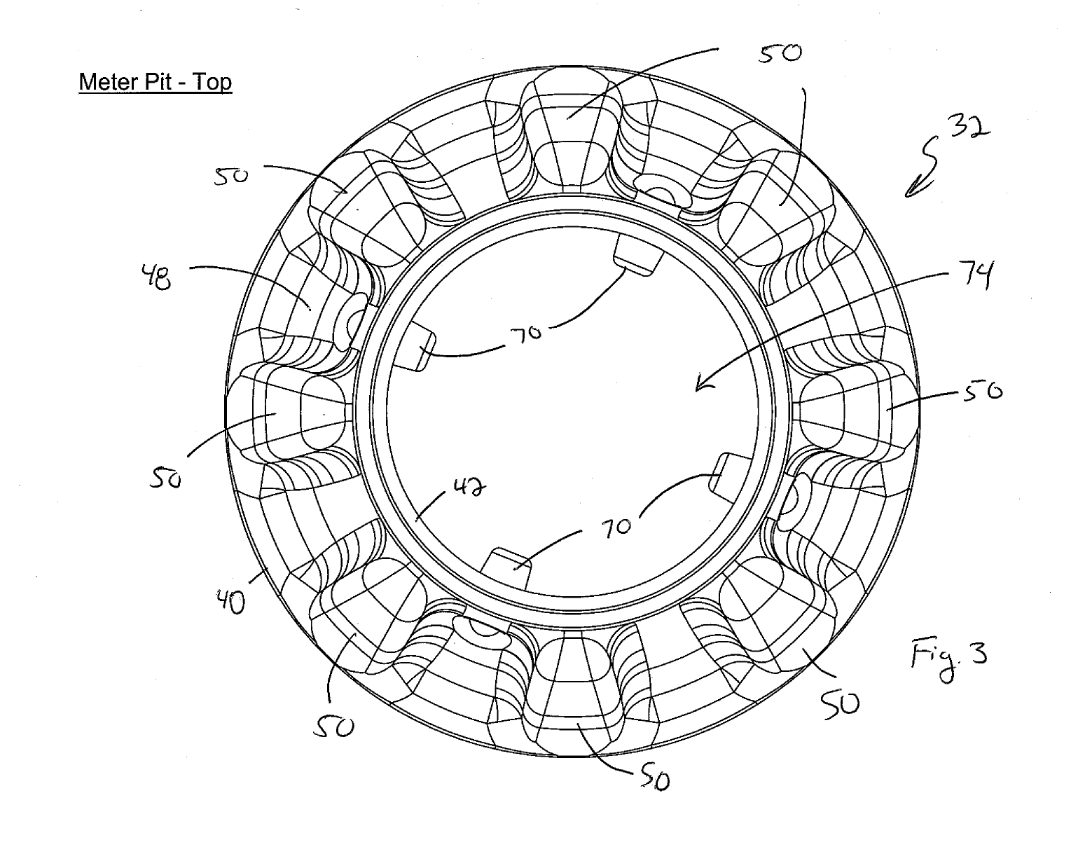

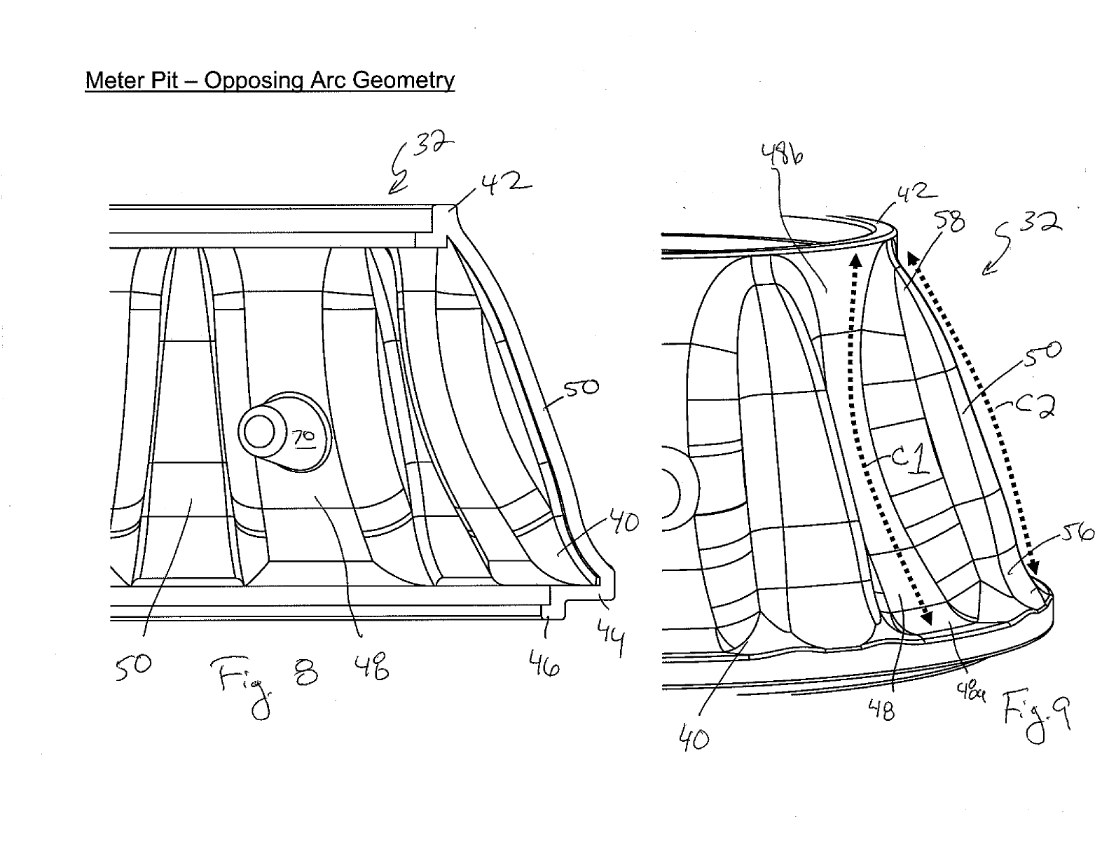

One example of the plastic frame 32 of the water meter pit assembly 30 is shown in greater detail in FIGS. 2-9. The plastic frame 32 is formed as a single-piece component using a roto-mold process. Any suitable plastic material for roto-molding can be used to form the frame. The roto-molding process includes pouring a powder composition into a mold. The mold is then closed and rotated in a heated environment. The mold rotates about one or more axes such that the powder inside the mold coats the inner surfaces of the mold. The mold is then cooled and opened such that the molded component can be released from the mold.

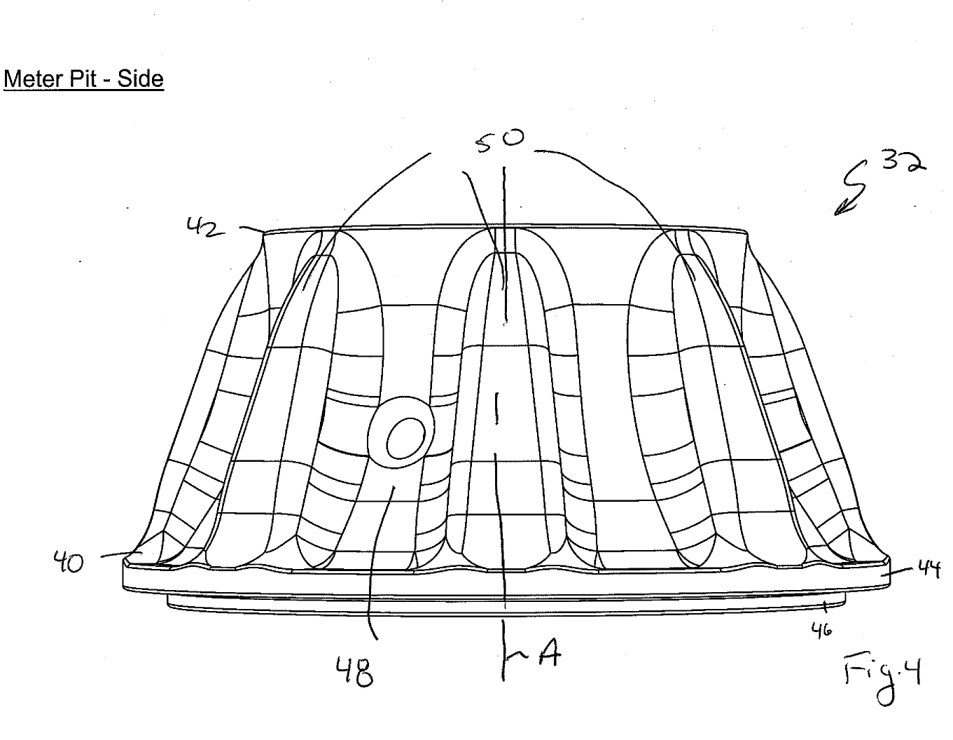

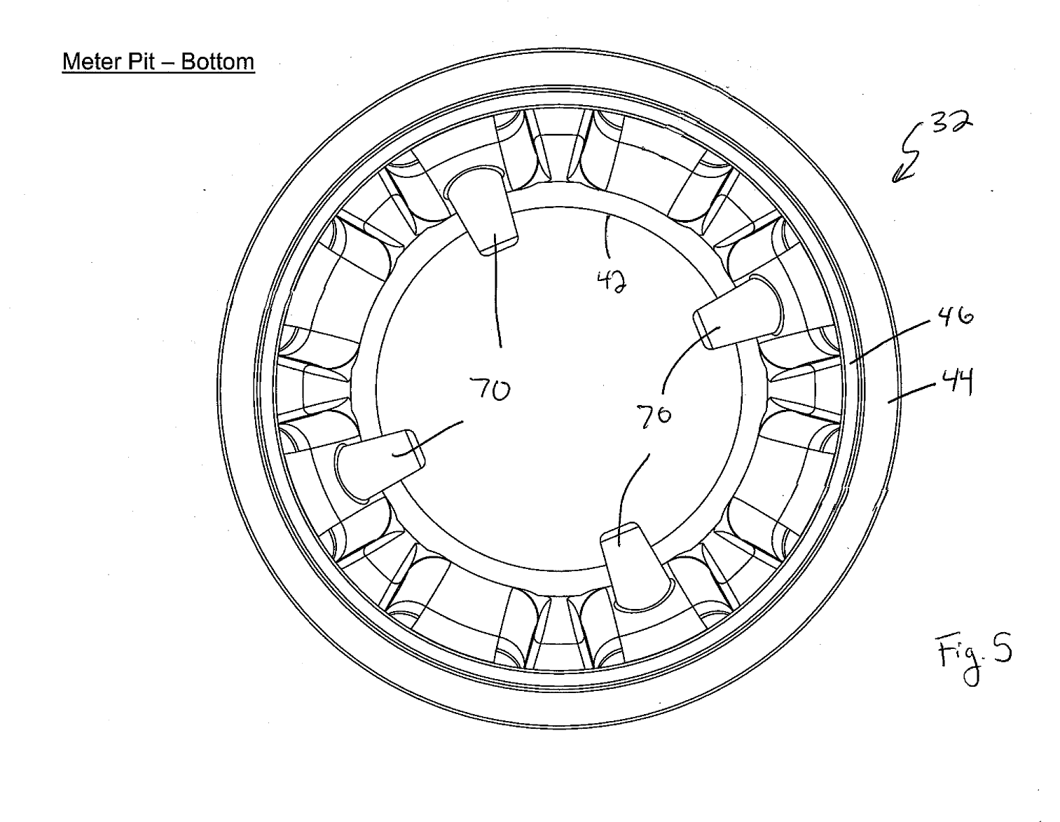

As discussed above, the plastic frame 32 must be able to support significant weight loads. The one-piece plastic frame 32 extends from a base end 40 up to a top end 42 that receives the cover 34. The base end 40 includes an outer flange 44 (FIGS. 4-5) that is formed about an outer periphery of the base end 40. A downwardly extending lip portion 46 is formed at the base end 40 and is received within the central opening 28 of the water pit column 22. The lip portion 46 is located radially inwardly of the outer flange 44. A bottom surface of the outer flange 44 rests on an upper edge of the water pit column 22 when the lip portion 46 is inserted into the central opening 28. Thus, the outer flange 44 and lip portion 46 cooperate to seat and fix the plastic frame 32 in position relative to the water pit column 22.

The frame 32 includes an outer surface 48 that decreases in diameter, i.e. tapers in an inward direction, from the outer flange 44 at the base end 40 to the top end 42. The outer flange 44 defines the largest outer diameter of the plastic frame 32 and the top end 42 defines the smallest outer diameter.

In addition to tapering from a large diameter end to a smaller diameter end, the outer surface 48 is comprised as an inwardly extending arcuate surface that is curved as indicated at C1 in FIGS. 2 and 9. Due to the taper, a bottom portion 48a of the outer surface 48 is located radially outwardly relative to a top portion 48b of the outer surface 48. Thus, the frame 32 is configured to provide an inward arched frame shape.

As best shown in FIGS. 2, 4, and 8-9, the frame 32 is also provided with an exterior arcuate rib configuration that extends outwardly from the outer surface 48 to increase frame strength. A series of exterior ribs 50 are formed within the outer surface 48 and extend in a generally linear direction from a location near the base end 40 in a direction toward the top end 42. The ribs 50 are circumferentially spaced apart from each about a center axis A (FIG. 4) defined by a center of the water meter pit assembly 30. Each rib 50 comprises a projecting or protruding portion that extends outwardly from the outer surface 48, with each rib 50 having an outwardly curved or arcuate surface being formed along a length of the rib 50 as indicated at C2. Further, this curved surface extends across a width of the rib 50 as indicated at C3.

Each rib 50 has base rib end 56 and a top rib end 58. The ribs 50 are wider at the base rib ends 56 than at the top rib ends 58. Thus, the ribs 50 form a series of finger-like protrusions that extend circumferentially about the frame 32. The outwardly curved ribs 50 are formed to complement the inward arched frame structure provided by the inwardly curved outer surface 48. The combination of these opposing shapes increases frame strength and decreases overall frame deflection.

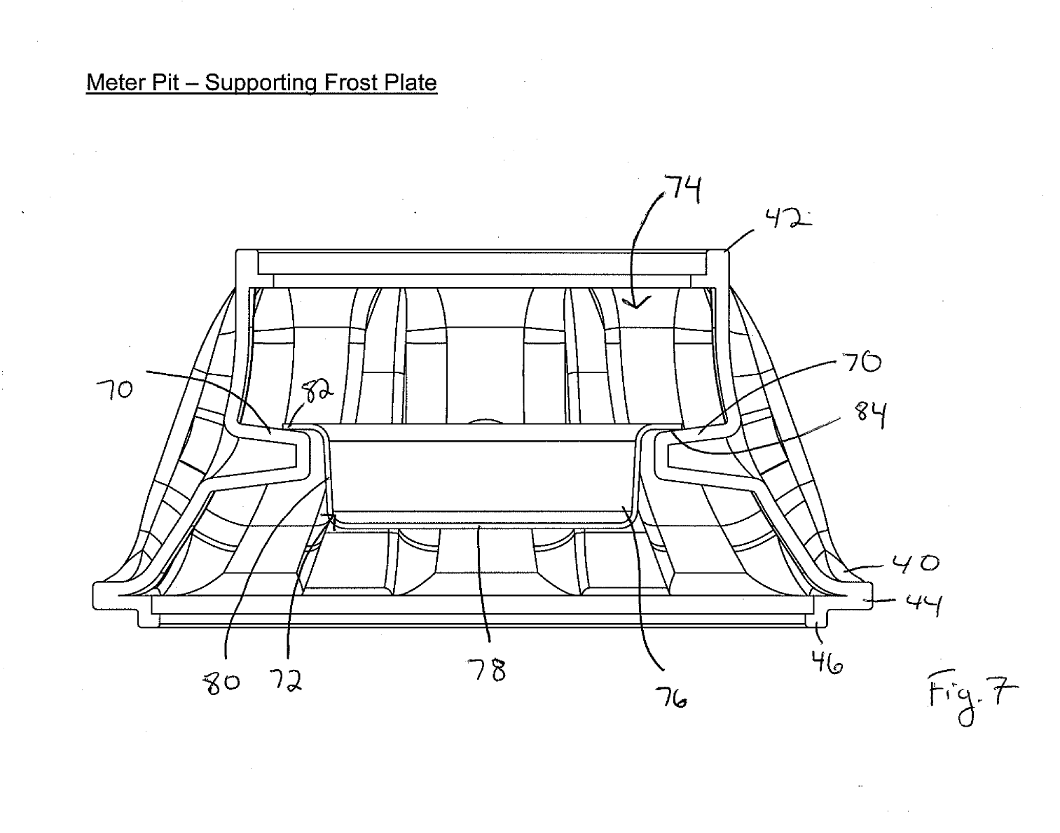

As best shown in FIGS. 2-3 and 5-7, the frame 32 includes at least one support 70 that is integrally molded as part of the frame 32. In the example shown, four molded supports 70 are shown; however, fewer or additional supports could be used as needed. The supports 70 comprise protrusions that extend radially inwardly toward the axis A. The supports 70 are configured to support a frost plate 72 (FIG. 7) that is received within an internal cavity 74 defined by the frame 32. The frost plate 72 comprises an optional structure that is not required for all meter pits.

As shown in FIG. 7, the frost plate 72 comprises a cup-shaped body 76 that has an enclosed bottom 78 that supports the transmitting component 36 (FIG. 1). The cup-shaped body 76 includes a vertically extending wall portion 80 that extends upwardly from the enclosed bottom 78 to an outwardly extending flange portion 82 formed about a periphery of the cup-shaped body 76. The outwardly extending flange portion 82 rests on an upper surface 84 of the supports 70.

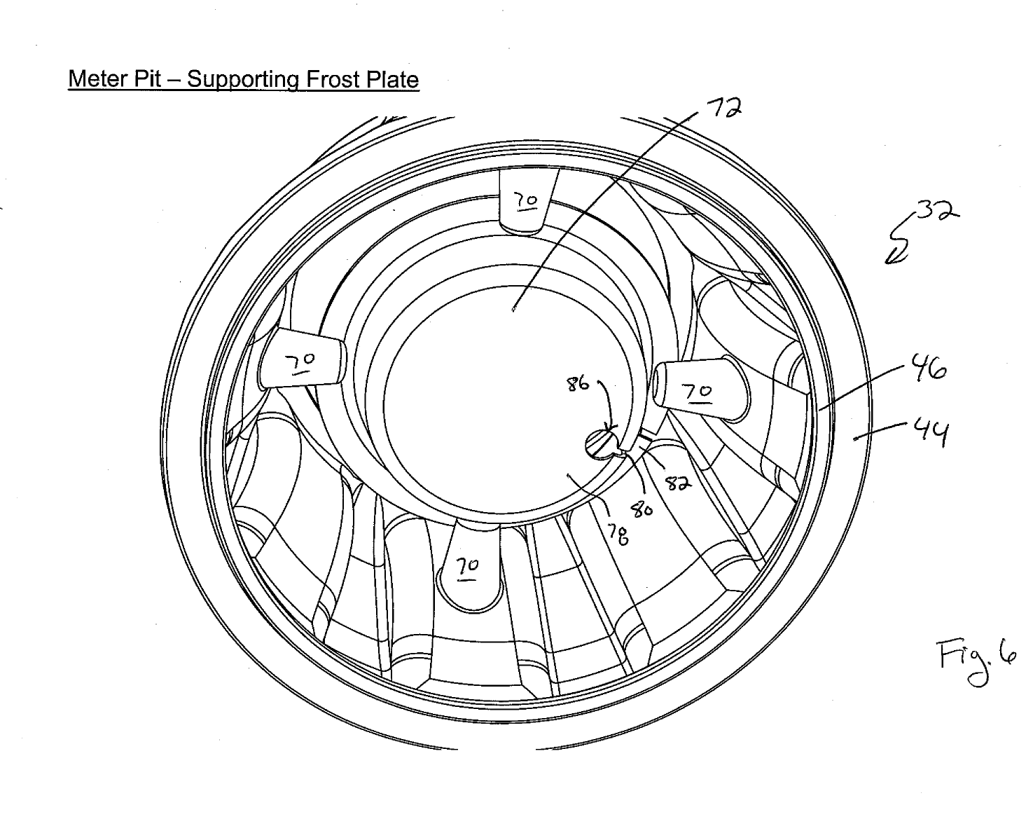

A wire guide portion 86 is formed within the cup-shaped body 76 (FIG. 6). The wire guide portion 86 extends upwardly along the vertically extending wall portion 80 and across the outwardly extending flange portion 82. The wire guide portion 86 supports the wire 38 connection (FIG. 1) that connects the water meter 10 to the transmitting component 36.

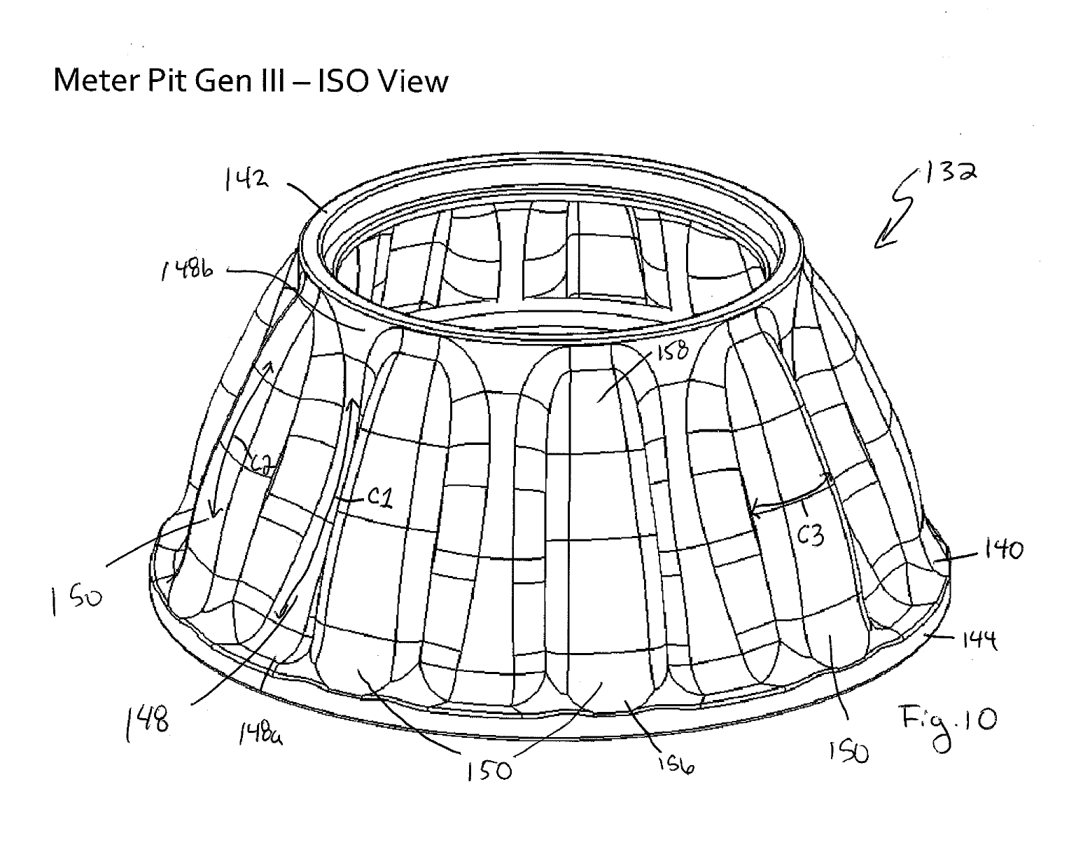

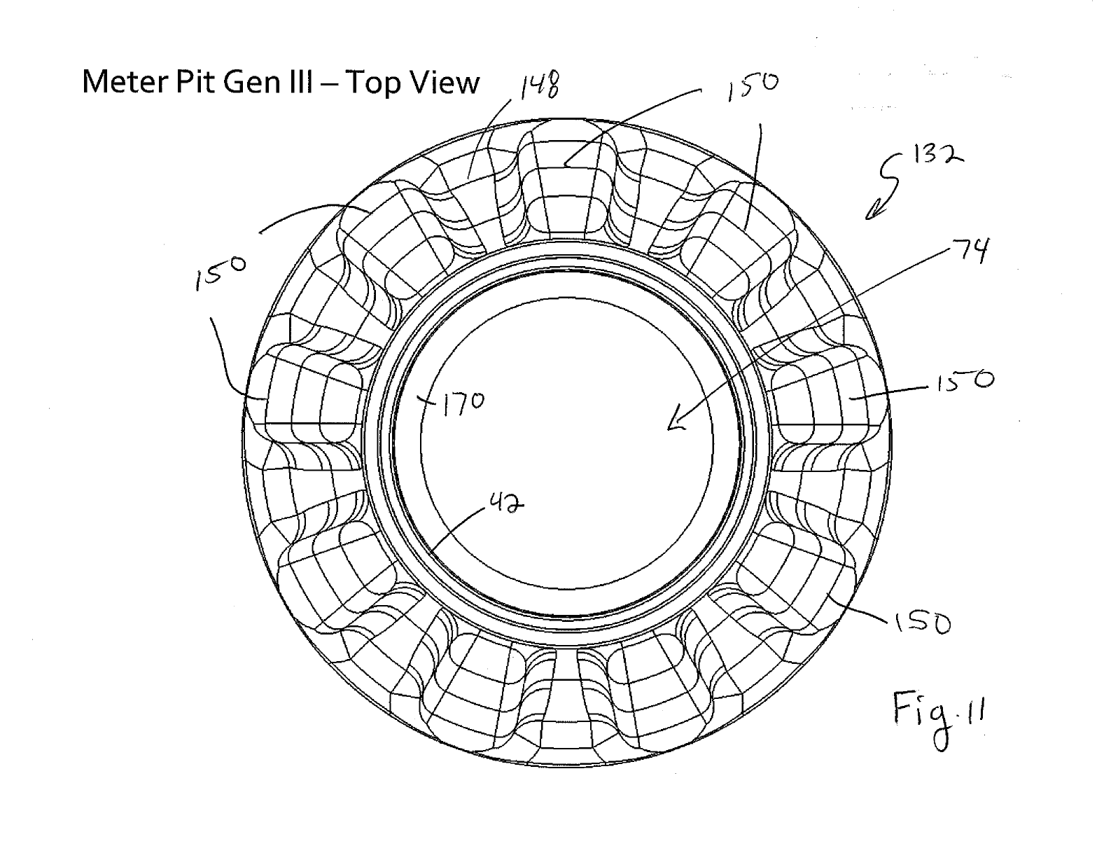

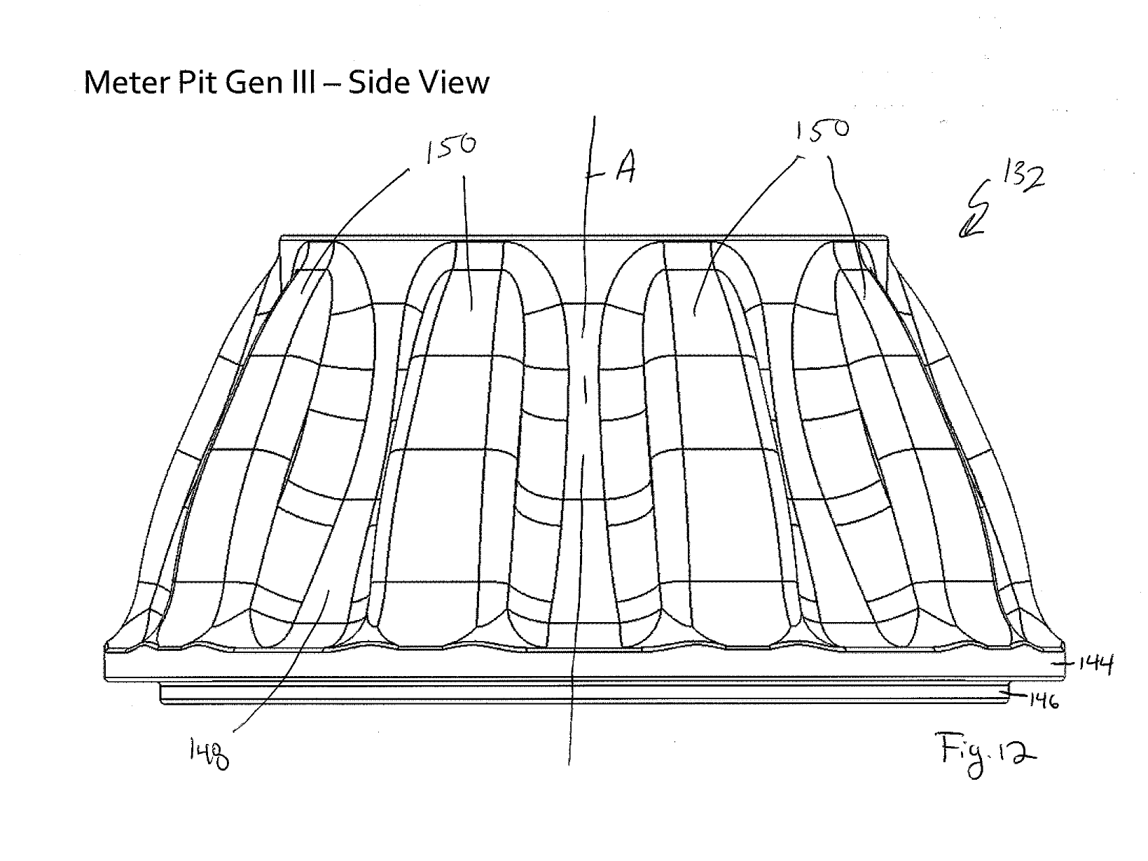

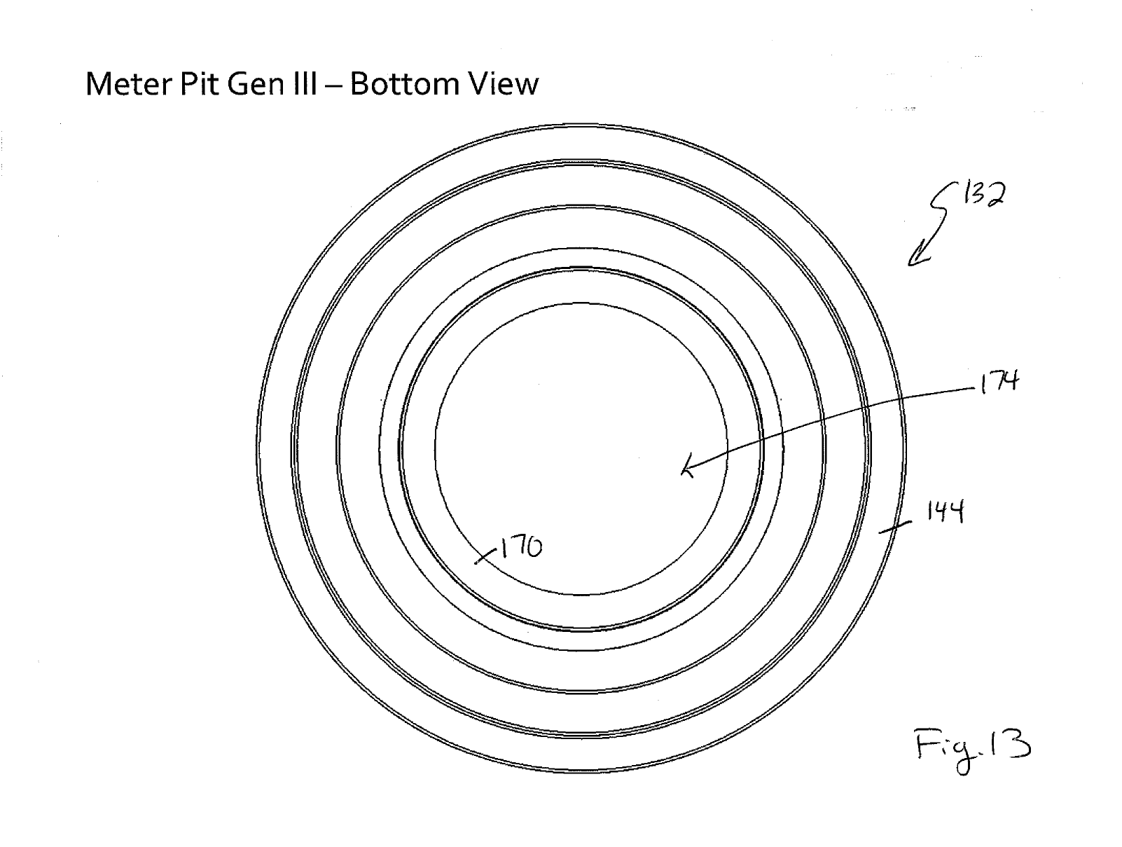

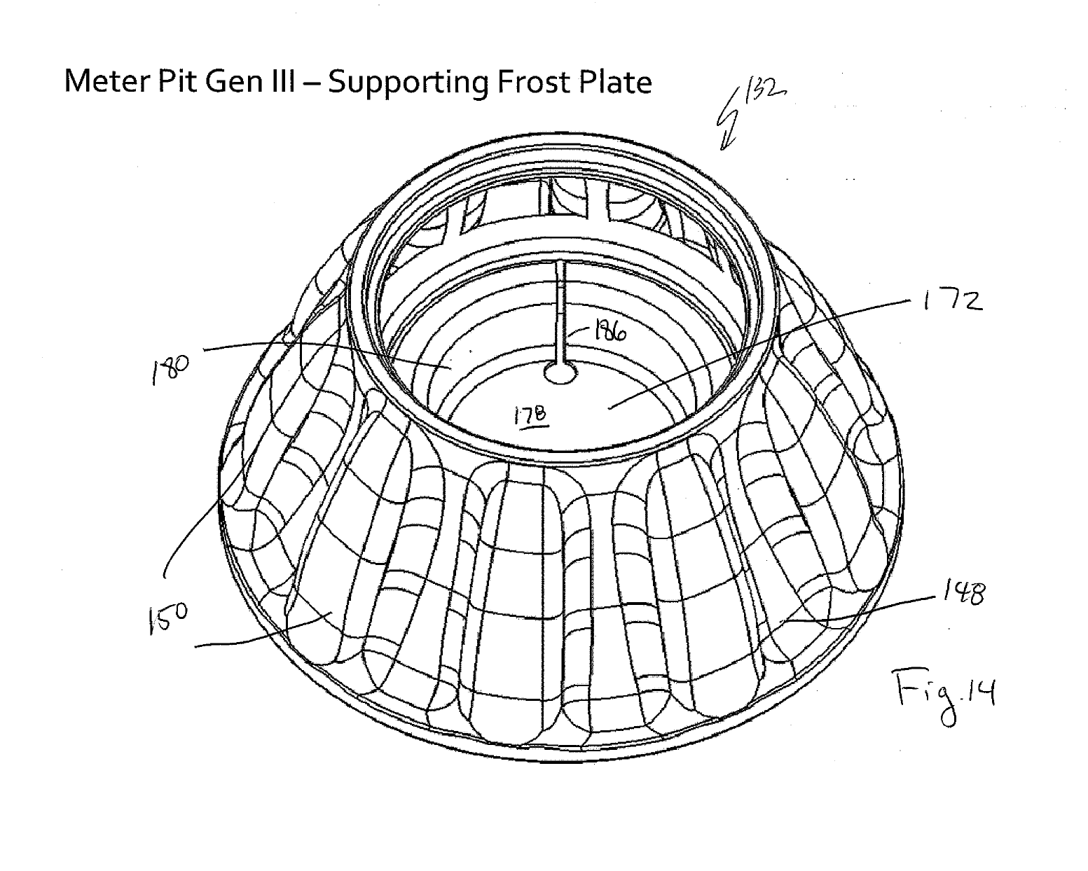

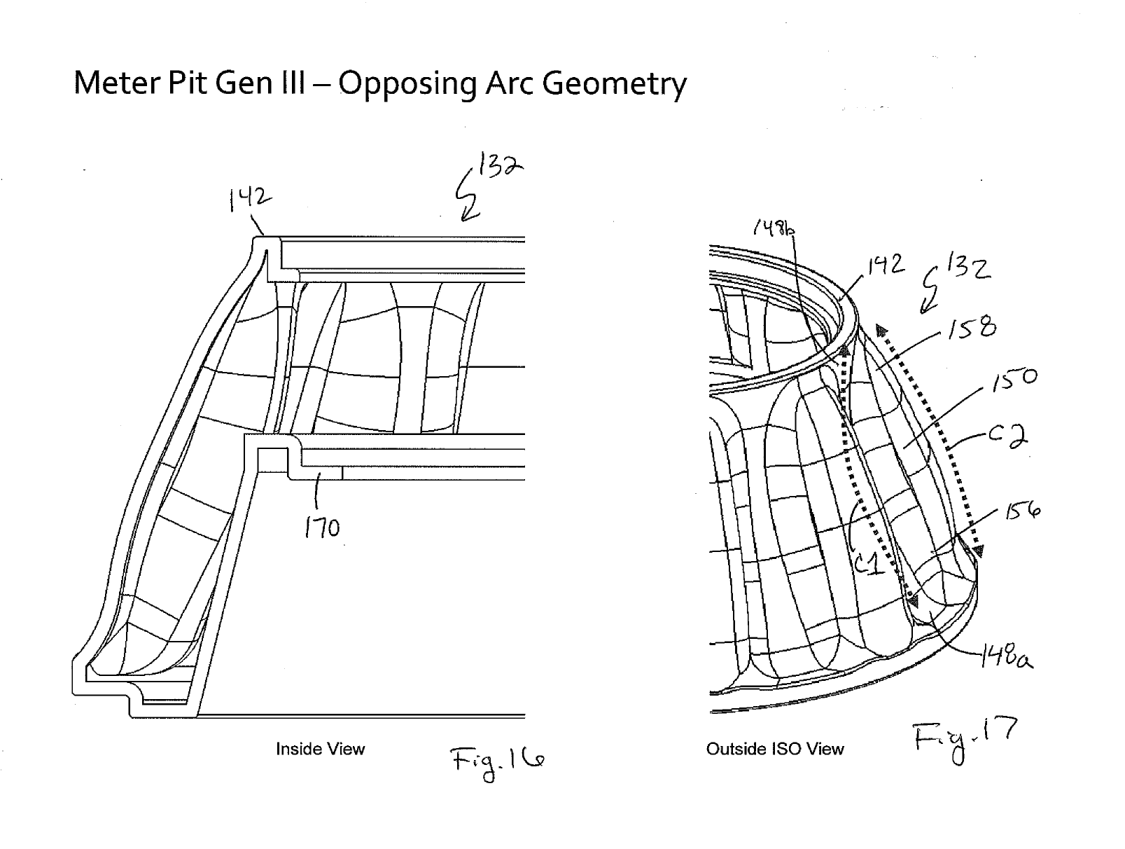

Another example of a plastic frame 132 of the water meter pit assembly 30 is shown in FIGS. 10-18. The plastic frame 132 is formed as a single-piece component using the roto-mold process discussed above. The one-piece plastic frame 132 extends from a base end 140 up to a top end 142 that receives the cover 34. The base end 140 includes an outer flange 144 (FIGS. 12-13) that is formed about an outer periphery of the base end 140. A downwardly extending lip portion 146 (FIG. 12) is formed at the base end 140 and is received within the central opening 28 of the water pit column 22. The lip portion 146 is located radially inwardly of the outer flange 144. A bottom surface of the outer flange 144 rests on an upper edge of the water pit column 22 when the lip portion 146 is inserted into the central opening 28. Thus, the outer flange 144 and lip portion 146 cooperate to seat and fix the plastic frame 132 in position relative to the water pit column 22.

The frame 132 includes an outer surface 148 that decreases in diameter, i.e. tapers inwardly, from the outer flange 144 at the base end 40 to the top end 142. The outer flange 144 defines the largest outer diameter of the plastic frame 132 and the top end 142 defines the smallest outer diameter.

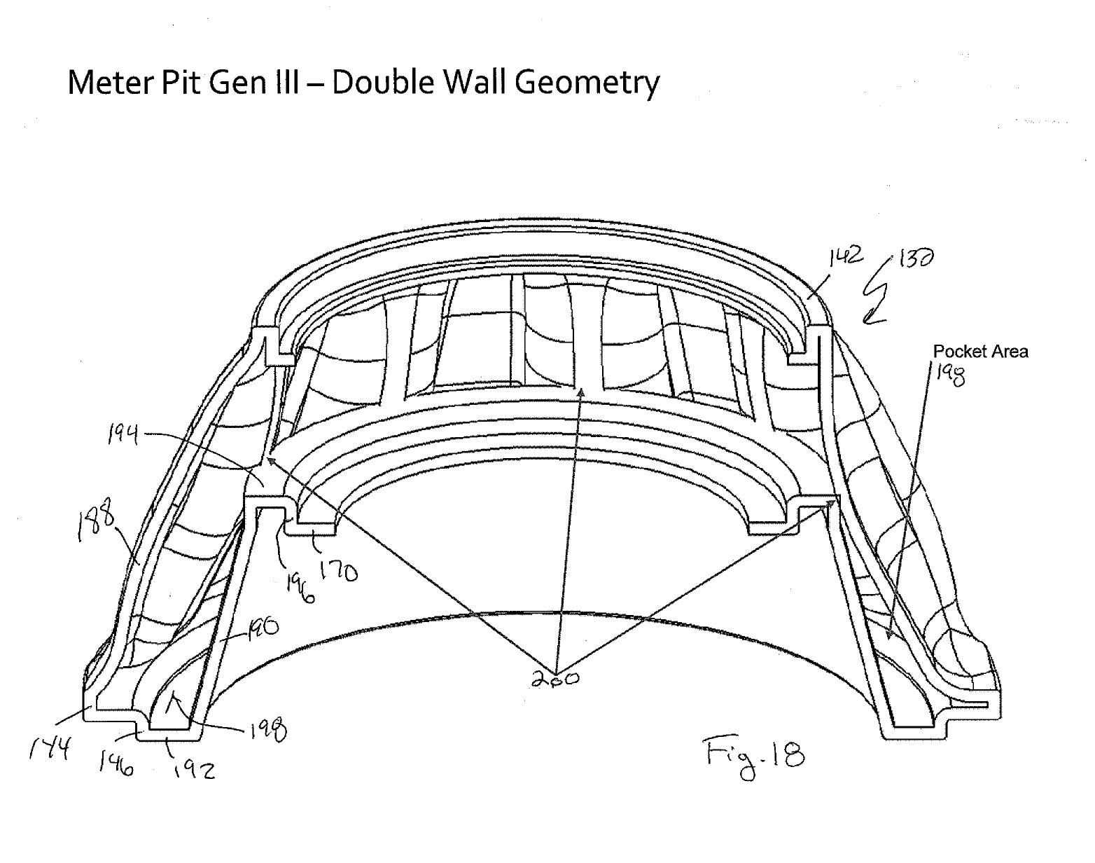

In addition to tapering from a large diameter end to a smaller diameter end, the outer surface 148 is comprised as an inwardly extending arcuate surface that is curved as indicated at C1 in FIGS. 10 and 17. Due to the taper, a bottom portion 148a of the outer surface 148 is located radially outwardly relative to a top portion 148b of the outer surface 148. Thus, the frame 132 is configured to provide an inward arched frame shape.

As best shown in FIGS. 10, 12, and 16-17, the frame 132 is also provided with an exterior arcuate rib configuration that extends outwardly from the outer surface 148 to increase frame strength. A series of exterior ribs 150 are formed within the outer surface 148 and extend in a generally linear direction from a location near the base end 140 in a direction toward the top end 142. The ribs 150 are circumferentially spaced apart from each about a center axis A (FIG. 12) defined by a center of the water meter pit assembly 30. Each rib 150 comprises a projecting or protruding portion that extends outwardly from the outer surface 148, with each rib 150 having an outwardly curved or arcuate surface being formed along a length of the rib 150 as indicated at C2 (FIG. 10). Further, this curved surface extends across a width of the rib 50 as indicated at C3.

Each rib 150 has base rib end 156 and a top rib end 158. The ribs 150 are wider at the base rib ends 156 than at the top rib ends 158. Thus, the ribs 150 form a series of finger-like protrusions that extend circumferentially about the frame 132. The outwardly curved ribs 150 are formed to complement the inward arched frame structure provided by the inwardly curved outer surface 148. The combination of these opposing shapes increases frame strength and decreases overall frame deflection.

As best shown in FIGS. 10-11 and 14-15, the frame 132 includes an inwardly extending lip or flange portion 170 that is integrally molded as part of the frame 132. In the example shown, the flange portion 170 extends completely about an inner periphery of the hollow frame 132; however, the flange portion 170 could be formed to extend partially about the inner periphery or to extend inwardly at discrete locations about the inner periphery. Formation of the flange portion 170 within the frame 132 will be discussed in further detail below.

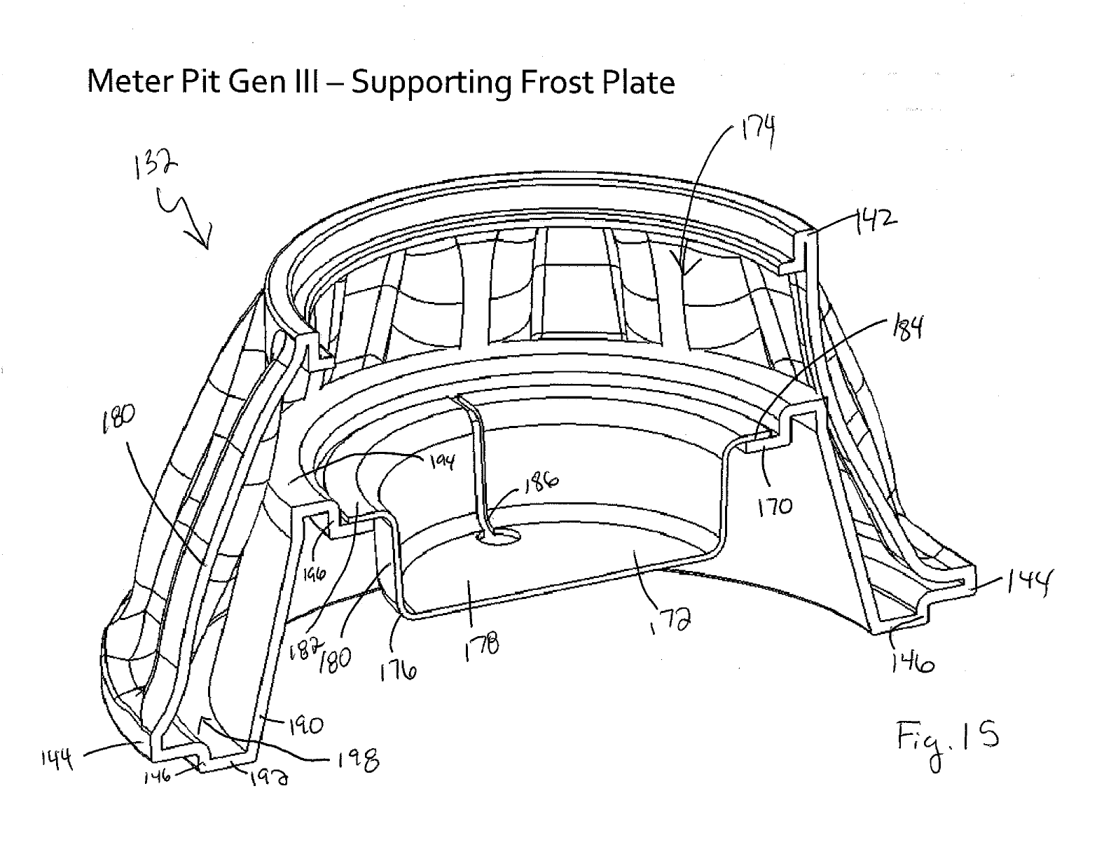

As shown, flange portion 170 extends radially inwardly toward the axis A. and is configured to support a frost plate 172 (FIG. 15) that is received within an internal cavity 174 defined by the frame 132. The frost plate 172 comprises an optional structure that is not required for all meter pits.

As shown in FIG. 15, the frost plate 172 comprises a cup-shaped body 176 that has an enclosed bottom 178 that supports the transmitting component 36 (FIG. 1). The cup-shaped body 176 includes a vertically extending wall portion 180 that extends upwardly from the enclosed bottom 178 to an outwardly extending flange portion 182 formed about a periphery of the cup-shaped body 176. The outwardly extending flange portion 182 rests on an upper surface 184 of the flange portion 170.

A wire guide portion 186 is formed within the cup-shaped body 76. The wire guide portion 186 extends upwardly along the vertically extending wall portion 180 and across the outwardly extending flange portion 182. The wire guide portion 186 supports the wire 38 connection (FIG. 1) that connects the water meter 10 to the transmitting component 36.

Also, as shown in FIG. 15, the frame 132 includes an inner wall structure 190 that is positioned radially inward of an outer wall structure 188 that defines the outer surface 148 of the frame 132. This forms a pocket portion 198 is formed between the outer wall structure 188 and the inner wall structure 190. Areas where the inner wall structure 190 and the outer wall structure 188 contact each other are indicated at 200 (FIG. 18). These contact areas 200 are located where the outer wall structure 188 curves inwardly as indicated by C1.

An inwardly extending flange portion 192 extends radially inwardly from the lip portion 146. The inner wall structure 190 tapers upwardly and inwardly from the flange portion 192 to a generally flat surface 194 that is positioned vertically above the flange portion 170 and below the upper end 142 of the frame. A transition wall portion 196 extends downwardly from surface 194 to the flange portion 170, which supports the frost plate 172. This configuration increases the overall structural strength of the frame 132 as wells as providing easy access to remove the frost plate 172 if needed.

The frost plate in either configuration comprises a plastic piece component. The frost plate can be formed by injection molding or a thermo-forming process, for example.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A water meter pit assembly comprising:
a plastic frame including a base portion to be supported by a water pit column and a top portion to be releasably securable to a plastic cover wherein the plastic frame comprises a one-piece structure extending from the base portion to the top portion.

2. The water meter pit assembly according to claim 1, wherein the plastic frame includes an outer flange integrally formed about an outer periphery of the base portion, the outer flange having a bottom surface configured to rest on top of an upper edge of the water pit column.

3. The water meter pit assembly according to claim 2, wherein the plastic frame includes a downwardly extending lip portion integrally formed about the base portion to be inserted within a central opening of the water pit column.

4. The water meter pit assembly according to claim 3, wherein the downwardly extending lip portion is located radially inward of the outer flange.

5. The water meter pit assembly according to claim 1, wherein the plastic frame is defined by an outer diameter that tapers inwardly in a direction extending from the base portion toward the top portion.

6. The water meter pit assembly according to claim 5, wherein the base portion is defined by a first outer diameter and the top portion is defined by a second outer diameter that is less than the first outer diameter.

7. The water meter pit assembly according to claim 6, wherein an outer surface of the plastic frame extending between the base and top portions comprises an inwardly extending arcuate surface.

8. The water meter pit assembly according to claim 1, wherein the plastic frame includes a plurality of ribs extending outwardly from an outer surface of the plastic frame.

9. The water meter pit assembly according to claim 8, wherein each rib extends in a generally linear direction from the base portion to the top portion.

10. The water meter pit assembly according to claim 9, wherein the ribs are circumferentially spaced apart from each other about the outer surface.

11. The water meter pit assembly according to claim 8, wherein each rib is defined by a length and a width wherein the length is greater than the width, and wherein at least one rib includes an arcuate surface extending at least along one of the length or width.

12. The water meter pit assembly according to claim 11, wherein the at least one rib includes a first arcuate surface extending in a direction along the length of the rib and a second arcuate surface extending along the width of the rib.

13. The water meter pit assembly according to claim 8, wherein each rib has a base rib end near the bottom portion and a top rib end near the top portion, and wherein each rib is wider at the base rib end than at the top rib end.

14. The water meter pit assembly according to claim 1, wherein the plastic frame defines a center opening extending from the base portion to the top portion, the center opening defining a central axis, and including at least one support integrally formed with the plastic frame and extending inwardly toward the central axis.

15. The water meter pit assembly according to claim 14, wherein the at least one support comprises a plurality of supports each extending inwardly toward the axis and being circumferentially spaced apart from each other about the axis.

16. The water meter pit assembly according to claim 14, including a frost plate positioned within the center opening and supported by the at least support.

17. The water meter pit assembly according to claim 1, wherein the plastic frame defines a center opening extending from the base portion to the top portion, the center opening defining a central axis, and including an inwardly extending flange integrally formed with the plastic frame and extending inwardly toward the central axis, the inwardly extending flange adapted to support a frost plate.

18. The water meter pit assembly according to claim 1, wherein the one-piece structure includes an outer wall structure and an inner wall structure spaced radially inwardly of the outer wall structure to form a pocket area.

19. The water meter pit assembly according to claim 18, wherein the outer wall structure extends to a first topmost surface and wherein the inner wall structure extends to a second topmost surface that is spaced vertically lower relative to the first topmost surface.

20. The water meter pit assembly according to claim 19, wherein the inner wall structure contacts the outer wall structure at a plurality of discrete contact areas circumferentially spaced apart from each other about a central axis defined by the frame.

21. The water meter pit assembly according to claim 19, wherein the inner wall structure includes at least one radially inwardly extending flange portion adapted to support a frost plate.

22. A water meter pit assembly comprising:
a plastic frame including a base portion to be supported by a water pit column and a top portion wherein the plastic frame comprises a one-piece structure extending from the base portion to the top portion, and wherein the plastic frame includes a center opening extending from the base portion to the top portion to provide access to a water meter located within a water meter pit; and
a plastic cover releasably securable to the plastic frame to enclose the water meter within the water meter pit.

23. The water meter pit assembly according to claim 22, wherein the plastic frame comprises an inward arched frame shape.

24. The water meter pit assembly according to claim 23, including a plurality of ribs extending outwardly from an outer surface of the plastic frame.

25. The water meter pit assembly according to claim 24 wherein each rib has an arcuate surface.

26. The water meter pit assembly according to claim 24 wherein each rib includes a first arcuate surface extending in a direction along a length of the rib and a second arcuate surface extending along a width of the rib.

27. The water meter pit assembly according to claim 26, wherein the plastic frame includes an outer flange integrally formed about an outer periphery of the base portion, the outer flange having a bottom surface configured to rest on top of an upper edge of the water pit column.

28. The water meter pit assembly according to claim 27, wherein the plastic frame includes a downwardly extending lip portion integrally formed about the base portion to be inserted within a central opening of the water pit column.

29. The water meter pit assembly according to claim 28, wherein the downwardly extending lip portion is located radially inward of the outer flange.

30. The water meter pit assembly according to claim 22, wherein the plastic frame is defined by an outer diameter that tapers inwardly in a direction extending from the base portion toward the top portion.

31. The water meter pit assembly according to claim 30, wherein an outer surface of the plastic frame extending between the base and top portions comprises an inwardly extending arcuate surface.

32. The water meter pit assembly according to claim 30, including a plurality of ribs extending outwardly from an outer surface of the plastic frame such that each rib has a base rib end near the base portion and a top rib end near the top portion, and wherein the ribs are circumferentially spaced apart from each other about a central axis defined by the center opening.

33. The water meter pit assembly according to claim 32, wherein each rib includes a first arcuate surface extending in a direction along a length of the rib from the base rib end to the top rib end and a second arcuate surface extending along a width of the rib.

34. A method of making a water meter pit frame comprising the steps of:
roto-molding a meter pit frame as a one-piece structure having a base portion to be supported on a water pit column and top portion to be releasably secured to a cover.

35. The method according to claim 34, further including
(a) pouring a powder composition into a mold,
(b) closing the mold,
(c) rotating the mold about one or more axes to coat an inner surface of the mold, and
(d) opening the mold to release a molded meter pit frame from the mold.

36. The method according to claim 35, further including rotating the mold in a heated environment and cooling the mold prior to step (d).

37. The method according to claim 36, including forming the meter pit frame to have an inward arched frame shape, the frame having an outer surface and an inner surface defining an internal cavity.

38. The method according to claim 37, including forming a plurality of ribs to extend outwardly from the outer surface of the meter pit frame such that each rib has a base rib end near the base portion and a top rib end near the top portion, and wherein the ribs are circumferentially spaced apart from each other about a central axis defined by a center opening through the meter pit frame, and further including forming each rib to have a first arcuate surface extending in a direction along a length of the rib from the base rib end to the top rib end and a second arcuate surface extending along a width of the rib.

39. The method according to claim 34, further including one of injection molding or thermo-forming a frost plate to be supported by the meter pit frame.
